(19) United States
(12) Patent Application Publication
(10) Pub. No.: US 2022/0164410 A1
(43) Pub. Date: May 26, 2022

(54) MULTIPROCESSOR MODELER AND SIMULATOR

(71) Applicant: Pradeep GUDLA, Paoli (US)

(72) Inventor: Pradeep GUDLA, Paoli (US)

(21) Appl. No.: 17/602,250

(22) PCT Filed: May 6, 2020
(86) PCT No.: PCT/US2020/031722

§ 371 Date: Oct. 7, 2021

Related U.S. Application Data
(60) Provisional application No. 62/843,780, filed on May 6, 2019.

(51) Int. Cl. G06F 17/13

(52) U.S. Cl. CPC G06F 17/13

(57) ABSTRACT

Solvers for differential equations associated with engineering problems for distributed computing environments employing a distributed queueing strategy that does not require synchronization.

### CROSS REFERENCE TO RELATED APPLICATIONS

The present application claims the benefit of U.S. provisional application No. 62/843,780, filed on May 6, 2019, the entire disclosure of which is incorporated by reference as if set forth in its entirety herein.

### FIELD

This disclosure relates to apparatus and methods for solving engineering problems, and more particularly to apparatus and methods for computationally solving differential equations representing engineering problems, which not only include problems in manufacturing but also problems involving physics based simulations and visualization in Augmented Reality, Virtual Reality, Gaming and Soft Tissue modeling, etc.

### BACKGROUND

Engineering problems are typically modeled using partial differential equations (PDEs), which are often solved using computers. As shown in FIG. 1, PDEs are solved on computers using computational modeling frameworks involving several steps.

These steps include reducing the hyperbolic or parabolic PDEs to a set of ordinary differential equations (ODEs) using space discretization. The ODEs are then time-discretized resulting in a set of algebraic equations which are then solved using principles of linear algebra. Often these steps are repeated iteratively until the desired numerical solution is obtained.

Elliptic PDEs that describe steady state behavior can be reduced to algebraic equations, with space-discretization alone. The resulting algebraic equations are solved using principles of linear algebra via direct or iterative techniques.

Popular choices for space-discretization of PDEs include Finite Element Methods (FEM), Finite Difference Methods (FDM), Finite Volume Methods (FVM), Particle Methods (PM), and Meshless Methods (MM), etc. Well known methods for time-discretization (or time-integration), include explicit and implicit Euler's method, Newmark methods, Runga-Kutta methods and multistep methods, to mention a few. Linear algebra based direct techniques for solving algebraic equations involve Gauss elimination, LU decomposition etc. Widely-used iterative techniques to solve algebraic equations include multigrid methods, fixed point iterative methods, conjugate gradient methods, etc.

These methods have been used extensively to solve several problems successfully. However, these techniques do not scale well for use in distributed computing environments or on today's multiprocessor chips because these methods were traditionally designed to produce serial instructions which are then programmed on a single processor computer for execution.

Much effort has been spent to parallelize the serial implementation algorithm, specifically parallelizing solution during a timestep update or during an iteration. However, the synchronization requirement at the end of each timestep or an iteration incur significant communication cost. As a result, in a distributed memory architecture, maximum speedup achieved is determined by the communication bandwidth available for data exchange between processors. In a hierarchical memory architecture or shared memory, bandwidth available to access remote memory locations will determine the maximum speedup achieved. Therefore, today's state of the art techniques are unable to fully exploit new generation multiprocessor architectures as well as large computing resources. As hardware manufacturers increase the number of computing cores to improve performance, benefits from these developments in architecture will become increasingly difficult to exploit for solving engineering problems.

Accordingly, there is a need for improved solution techniques that avoid the shortcomings of existing methods.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Several embodiments described herein relate to distributed solvers for differential equations typically encountered when solving engineering problems. Embodiments of the present invention eliminate the final vestige of the serial nature of computational methods designed decades earlier, ensuring that scientific computations are no more limited by communication constraints and enabling faster simulations of all sizes in a distributed computing environment.

In one aspect, embodiments of the present invention relate to a computer-implemented method for solving engineering problems. The method includes receiving, at an interface, a geometric description of a problem domain, a partial differential equation and boundary conditions representative of an engineering problem. The partial differential equation and boundary conditions in the problem domain are converted into at least one algebraic equation using a discretizer. The at least one algebraic equation is decomposed into a plurality of local vectors for solution using a partitioner. Each local vector is assigned to a processor for solution using a scheduler. An error controller keeps the error in each local vector less than a specified value or minimizes the error for faster convergence. A solution to the partial differential equation and boundary conditions is communicated using the interface.

In this aspect, each processor solves its assigned local vectors without waiting for data from other processors or from a remote memory location while tracking the solution error associated with solving the local vector.

In some embodiments converting the partial differential equation and boundary conditions into at least one algebraic equation comprises at least one of spatial discretization and time discretization. In some embodiments converting comprises spatial discretization selected from the group consisting of Finite Element Methods (FEM), Finite Difference Methods (FDM), Finite Volume Methods (FVM), Particle Methods (PM), and Meshless Methods (MM). In some embodiments converting comprises time discretization selected from the group consisting of explicit Euler's method, implicit Euler's method, Newmark methods, Runga-Kutta methods, and multistep methods.

In some embodiments, the error controller for time domain analysis adapts at least one discretization parameter of each local vector independent of other local vectors to keep the solution error less than a specified value. In some embodiments the at least one discretization parameter is associated with time discretization, space discretization or both.

In some embodiments, local vectors are reassigned among processors at runtime by the scheduler so as to reduce the difference in time changes or evolution across the plurality of processors.

In some embodiments, assigned local vectors with current data are prioritized over assigned local vectors that are waiting for data.

In another aspect, embodiments of the present invention relate to a system for solving engineering problems. The system includes a memory, a plurality of processors, an interface, a discretizer, a partitioner, a scheduler, and a bus. The memory has computer-executable instructions and data stored therein. Each of the processors is in communication with the memory as well as the other processors, and has a queue for computational tasks. The interface is configured to receive a geometric description of a problem domain, a partial differential equation and boundary conditions representative of an engineering problem and to output a solution for the partial differential equation and boundary conditions. The discretizer converts the partial differential equation in the problem domain into at least one algebraic equation. The partitioner converts the at least one algebraic equation into a plurality of local vectors for solution. The scheduler assigns each local vector to a processor for solution. The bus is for intermittent communications among processors and memory.

In this aspect, each processor solves its assigned local vector without waiting for data from other processors or from a remote memory location while tracking the solution error associated with solving the local vector.

In some embodiments, the memory is at least one of a distributed memory architecture, a shared memory architecture, and a hierarchical memory architecture.

In some embodiments, the discretizer converts the partial differential equation into at least one algebraic equation using at least one of spatial discretization and time discretization. In some embodiments, the discretizer utilizes spatial discretization selected from the group consisting of Finite Element Methods (FEM), Finite Difference Methods (FDM), Finite Volume Methods (FVM), Particle Methods (PM), and Meshless Methods (MM). In some embodiments, the discretizer utilizes time discretization selected from the group consisting of explicit Euler's method, implicit Euler's method, Newmark methods, Runga-Kutta methods, and multistep methods.

In some embodiments, the error controller for time domain analysis adapts at least one discretization parameter of each local vector independent of other local vectors to keep the solution error less than a specified value. In some embodiments, the at least one discretization parameter is associated with time discretization, space discretization or both.

In some embodiments, the scheduler reassigns local vectors at runtime among the plurality of processors so as to reduce the difference in time changes or evolution across the plurality of processors.

In some embodiments, assigned local vectors with current data are prioritized over assigned local vectors that are waiting for data.

### BRIEF DESCRIPTION OF THE DRAWINGS

The accompanying drawings are not intended to be drawn to scale. In the drawings, each identical or nearly identical component that is illustrated in various figures may be represented by a like numeral. For purposes of clarity, not every component may be labeled in every drawing. Various embodiments will now be described, by way of example, with reference to the accompanying drawings, in which:

FIG. 1 depicts a prior art computational modeling framework;

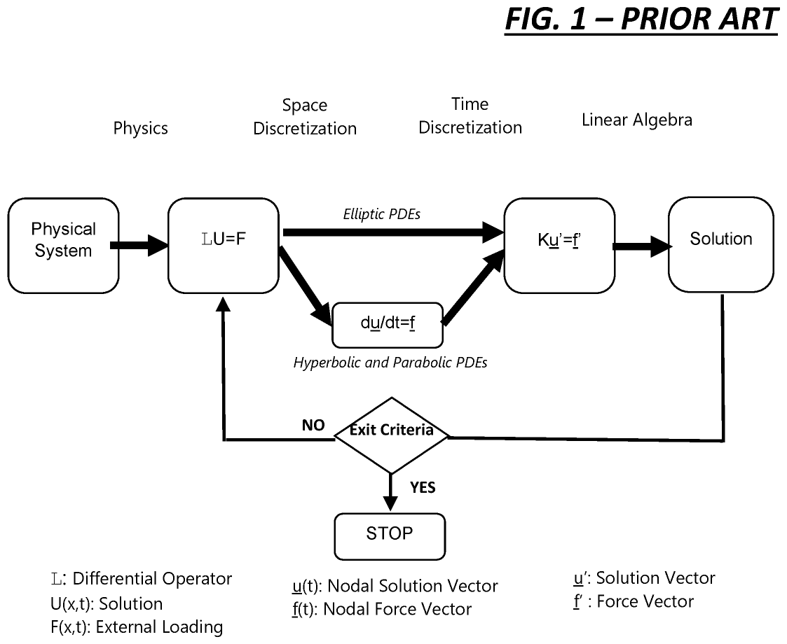

FIG. 2 depicts one embodiment of a solver in accord with the present invention;

FIG. 3 is a flowchart of a method for solving engineering problems in accord with the present invention; and

FIG. 4 is a flowchart expanding on Steps 312-16 from FIG. 3.

### DETAILED DESCRIPTION

As a preliminary matter, it will readily be understood by one having ordinary skill in the relevant art that the present invention has broad utility and application. As should be understood, any embodiment may incorporate any one or combination of the disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention.

Additionally, it is important to note that each term used herein refers to that which one of ordinary skill would understand such term to mean based on the contextual use of such term herein. To the extent that the meaning of a term used herein—as understood by one of ordinary skill based on the contextual use of such term—differs in any way from any particular dictionary definition of such term, it is intended that the meaning of the term as understood by one of ordinary skill should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers,” “a picnic basket having crackers without cheese,” and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, in which like numerals represent like components throughout the several views, one or more embodiments of the present invention are next described. The following description of one or more embodiment(s) is merely exemplary in nature and is in no way intended to limit the invention, its application, or uses.

Embodiments of the present invention function particularly well in distributed computing environments or on multiprocessor chips because, as discussed below, they employ a distributed queueing strategy that uses a combination of independent updating, error control, and load distribution algorithm to remove the synchronization requirement completely and convert the communication bound simulations to an embarrassingly parallel simulations. That is, compared to prior art solvers (discussed above), embodiments of the current invention do not require synchronization among distributed processors nor do they require satisfaction of the causality condition in time domain analysis, i.e., in requiring that all computations associated with adjoining sub-domains at time t be completed before commencing computations for, e.g., time t+dt.

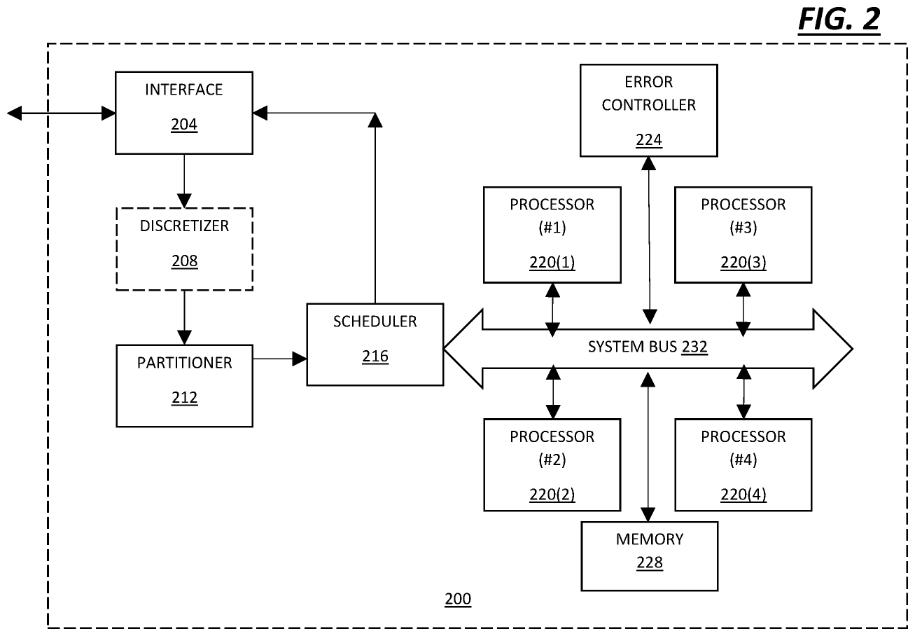

FIG. 2 is a block diagram of one embodiment of a solver 200 implementing the distributed queueing strategy of the present invention. The solver 200 includes an interface 204, a discretizer 208, a partitioner 212, a scheduler 216, a plurality of processors 220(n), an error controller 224, a memory 228, and a system bus 232 interconnecting these components and permitting them to communicate.

One of ordinary skill will recognize that each of these depicted elements is, to some extent, an abstraction. Any or all of these elements may be implemented in software executing on off-the-shelf hardware, as custom hardware (such as an application-specific integrated circuit), or as a combination thereof. Moreover, the same hardware components may implement multiple elements, e.g., the discretizer 208 and partitioner 212 may be implemented as software processes executing on the same general-purpose central processing unit, the “processors” 220(n) may be physical or virtual processors executing on local integrated circuits or in a remote cloud computing platform, etc. In the same vein, some embodiments will feature a single element, such as a scheduler or error controller, servicing a plurality of processors and other elements, while in other embodiments the “single” scheduler may well comprise a plurality of schedulers, each scheduler associated with a processor or other element.

The interface 204 allows for communications with the solver 200. For example, a user may supply one or more partial differential equations with boundary conditions and a geometric description of the problem domain representative of an engineering problem to the solver 200 using an interface 204 like a keyboard, speech recognition, or an imager that captures and decodes an image of a differential equation. In other embodiments, the interface 204 may permit programmatic communications, e.g., through software or graphical user interfaces, that allow for the direct or indirect presentation of a three-dimensional model of the problem domain, differential equations and boundary conditions to the solver 200.

After the solver 200 receives one or more partial differential equations with boundary conditions and a three-dimensional model of the problem domain at the interface 204, the discretizer 208 applies a discretization technique to convert the partial differential equations to a system of algebraic equations. This can take the form of, e.g., using spatial discretization to convert the partial differential equations to ordinary differential equations, and then time discretizing the ordinary differential equations to yield a system of algebraic equations for solution. Alternately, a system of elliptic partial differential equations may be presented to the interface 204, obviating the need for time discretization; a system of ordinary differential equations may be presented to the interface 204, obviating the need for spatial discretization; a system of algebraic equations may be presented directly to the interface 204 obviating the need for a discretizer 208 altogether, etc.

The system of algebraic equations for solution is now supplied to a partitioner 212 which decomposes the global vectors associated with the system into a plurality of local vector sets, each local vector set associated with a subdomain. Note that several of the local vector sets can be associated with the same subdomain, representing different physics or different length scales, etc.

The scheduler 216 assigns each local vector to a processor 220(n) for solution, each processor having its own queue for computational tasks (not shown). In some embodiments, the processor 220(n) returns its index back to the scheduler 216 after it finishes updating the assigned local vectors and then scheduler reassigns the local vector to another processor 220(n), which may or may not be the same processor 220(n) that returned the index to the scheduler 216; as discussed below, in some embodiments, this reassignment may be done to account for resource constraints or achieve uniform time changes or evolution across sub-domains or errors introduced in the solution process.

This approach has the advantage of achieving close to full utilization of processor compute cycles, since processors do not wait for data from other processors or from a remote memory location. This remains true even in high latency computations, i.e., where all processors are experiencing delay in receiving data in a consistent manner, as well as in heterogenous computing environments such as cloud computing environments where communication bandwidth between processors is not uniform and on multiprocessor chips, where memory bandwidth to access memory is not uniform.

Computationally, updating each local vector requires information from other local vectors which may or may not be assigned to the same processor 220(n). An index from a list on a processor 220(n) is chosen based on a criteria and the local vector associated with the index is examined for updating. If all the current data required for updating the local vector is available, then the updating step is given higher priority, executed, or both. If all or some of the current data required for updating the local vector is unavailable, then the chosen index is pushed into a waiting list queue. Another index from the list is chosen and the process is repeated. When the list is empty the local vectors from the waiting list queue are updated despite not having current copy of required data.

In short, local vectors are updated without waiting for current data when there is no other local vector on a processor with all the current data for updating, available. Overall a processor never idles waiting for data from other processors, giving higher preference for evaluating local vectors with all current data available over local vectors that are awaiting data from other processors.

However, this independent updating approach effectively converts the communication cost to a computational error. While the additional computational error may result in increased number of iterations before convergence while solving elliptic partial differential equations, this could lead to numerical instability in time domain analysis. Accordingly, embodiments of the present invention employ error control strategies based on local error estimates. In particular, during each update of the local state vector, various parameters of discretization (e.g., mesh size, length of time step, etc.) may be adjusted by the error controller 224 so as to keep the estimated error below a desired threshold or minimize, so as to maintain accuracy or to improve solution convergence.

Adjusting the discretization by the error controller 224 can be a single step process, where the discretization parameters are adapted as the local vector is updated. This plays an important role in allowing independent updating of local vectors and convert the additional error resulting from delay in current data into more arithmetic operations or flops for time domain analysis. As a result, asynchronous time stepping methods, which allow independent timestep to be used for each local vector and hence naturally allows independent updating during time domain analysis, is a popular choice for time domain discretization. Since the invention uses a local copy of the data in place of the current data to avoid high cost of network or memory latency, a better approximation of the current data using historical values will help reduce the cost of the delay. However, some of the discretization parameters adjusted by the error controller 224 can be a two-step process, such as mesh element size adaptation in mesh-based simulations. Based on the error estimate due to space discretization, some of the local vectors are staged for refinement or de-refinement. After every few updates, mesh refinement/de-refinement of all the local vector or associated subdomains is carried out. Such an adjustment can require coordination among local processors and can be easily carried out without waiting or causing minimal delay.

The particular parameters available for adjustment will depend on the differential equation and the discretization techniques used. For example, when solving elliptic partial differential equations only space discretization can be adapted. Similarly, when solving hyperbolic or parabolic partial differential equations timestep adaptation is not allowed when finite difference methods are used. In finite element methods and finite volume methods, where space discretization is done first, and therefore mesh size adaptation is not allowed. Only when space and time domains are both discretized simultaneously are both timestep and mesh size allowed to be changed. In a more recent class of discretization techniques including meshless methods, one or more of time discretization, nodal density and other solution enrichment parameters can be changed.

In some embodiments, the computational error introduced by independent evolution of different local vectors across different processors may be mitigated by reallocating computational resources. For example, if some of the local vectors are evolving slowly, i.e., if processor time consumed per timestep or iteration is high, e.g., owning to greater computational requirements, it will slow down the evolution of neighboring local vectors and eventually the whole system. In response, the scheduler 216 may allocate additional computing resources to those vectors or reassign local vectors among processors 220(n) to reduce errors arising due to non-uniformity in evolution of local vectors across processors and help minimize the duration of the simulation. Depending upon the architecture implementing the solver, which can be a distributed memory architecture 228, a shared memory architecture 228, or a hierarchical memory architecture 228 which is a combination of both, the specific implementation of the load distribution algorithm may vary.

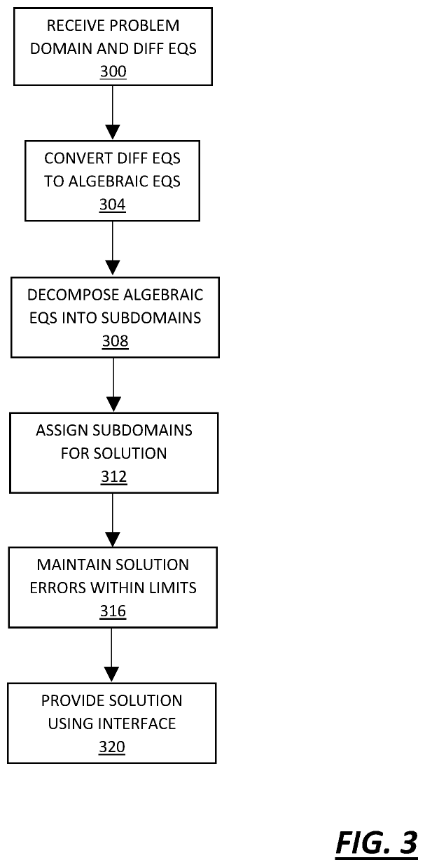

FIG. 3 presents a flowchart of a method for solving engineering problems in accord with the present invention. The process begins with the receipt, at an interface, of a three-dimensional model of the problem domain, a partial differential equation and boundary conditions representative of an engineering problem (Step 300). The three dimensional model with partial differential equation and boundary conditions are converted, using a discretizer, into at least one algebraic equation (Step 304). Next, the at least one algebraic equation is decomposed, using a partitioner, into a plurality of local vectors for solution (Step 308). Each local vector is assigned to a processor for solution using a scheduler (Step 312).

Each processor solves its assigned local vectors independent of other assigned processors without waiting for data from other processors while an error controller monitors the error associated with each local vector and takes appropriate measures to minimize or maintain the error within desired levels (Step 316). In some embodiments, the error controller will adjust discretization parameters (e.g., time discretization) independent of the other local vectors (via a single step adjustment of discretization) to limit the error. In some embodiments, the scheduler will reassign local vectors at runtime to limit the error. Once the solution is completed, it is communicated using an interface (Step 320).

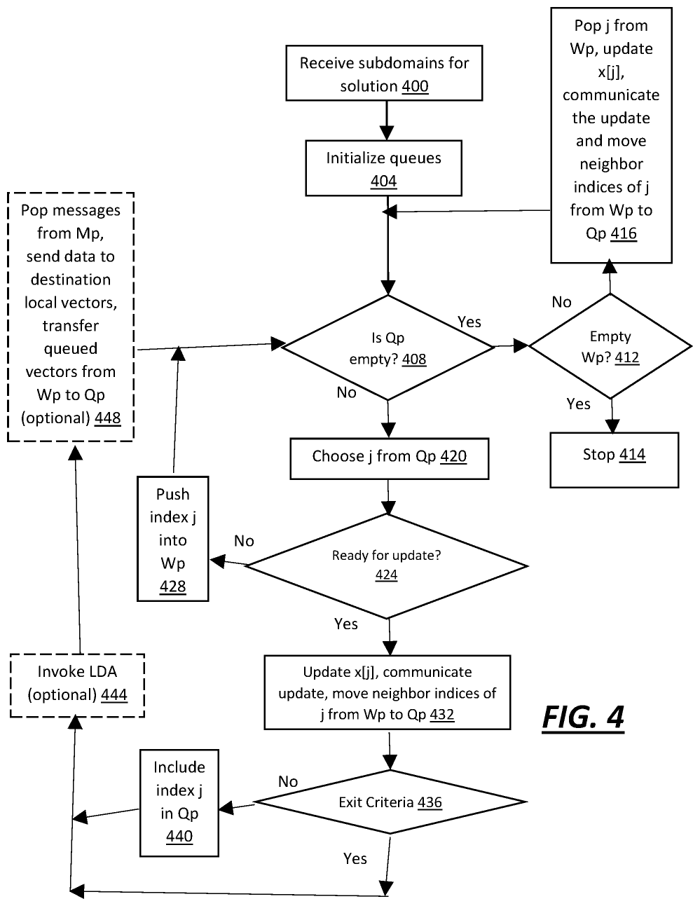

FIG. 4 presents a flowchart that expands upon the process of assigning and solving local vectors in accord with the present invention. As discussed above, after the algebraic equations are decomposed into a plurality of local vectors (Step 308), the local vectors are assigned among processors for solution (Step 312). Each processor (p), having been assigned a plurality of local vectors (Step 400), maintains a list (Qp), a waiting queue (Wp), and a message queue (Mp) which stores messages in a first-in, first-out fashion. The indices of the local vectors assigned to each processor are listed in Qp while Mp and Wp, which stores an ordered list of indices of the local vectors waiting for data from other processors, are both initialized as empty queues (Step 404). Generally speaking, in Wp a local vector with the least evolution is prioritized for updating over a local vector that is ahead in its evolution.

Execution begins with each processor checking its Qp for an index (Step 408). If Qp is not empty, the index j is chosen from Qp such that separation of evolution among all local vectors assigned to a particular processor p is minimal (Step 420) and checked to see if the current data, i.e., the latest copy of the data required to update the associated local vector (i.e., x^{[j]}) is available (Step 424). If the current data is not available, index j is inserted in Wp such that the local vectors with lower evolution are higher in the queue than the local vectors with higher evolution (Step 428) and the process repeats, starting again by checking Qp for an index (Step 408).

If the current data is available, the local vector x^{[j]} is updated, the update is communicated to all the local vectors that require the updated data and, if any of the local vectors that received the updated data are in Wp, then they are transferred back to Qp (Step 432). If any of the local vectors that require the updated data from the local vector x^{[j]} are assigned to a different processor, the updated information is sent to a communication buffer (not shown). From the communication buffer, once enough data is available to be sent to a destination processor, a non-blocking communication is sent to a remote processor and the data is pushed into the message queue on the remote processor (not shown).

If exit criteria (Step 436) are not met, index j is listed back in Qp (Step 440). If the local vector x^{[j]} meets the exit criteria (Step 436) because, e.g., it has evolved to the desired level and needs no more updates, then for the rest of the simulation local vector x^{[j]} is omitted.

Regardless of whether the exit criteria (Step 436) are satisfied, the load distribution algorithm may optionally be invoked upon the satisfaction of certain criteria (Step 444) and the message queue may optionally be checked (Step 448) before the process starts again by checking if Qp is empty (Step 408). The load distribution algorithm (Step 444) essentially reallocates local vectors among processors such that the evolution of local vectors across processors is uniform. In one embodiment, the load distribution algorithm includes moving, at a certain frequency, a least evolved local vector to a processor that hosts the most evolved local vector.

Similarly, if the criteria for checking the message queue are met, then all messages from Mp are popped and sent to their destinations (Step 448). If any of the local vectors that received data from these messages are waiting in Wp, then they are transferred to Qp to see if they are ready for updating (Step 448).

During execution, whenever Qp is found to be empty (Step 408), Wp is also checked to see if it is empty (Step 412). If Wp is not empty, the top index from the Wp is popped, the associated local vector is updated, the update is communicated and, if any of the local vectors that would receive the update are in their processor's Wp, they are moved to their processor's Qp (Step 416). Again the control moves to check if Qp is empty (Step 408) and the process repeats.

When Qp is empty and there are no more local vectors waiting for additional data, i.e., Wp is empty (Step 412), the processor stops executing any tasks and waits for the simulation to be terminated (Step 414). The simulation terminates when all of the processors have stopped executing and the simulation results are transferred. The embodiment of FIG. 4 is an example of an implementation in a distributed memory architecture and, as recognized by one of ordinary skill, is neither the only implementation possible nor is it the most efficient implementation possible. The actual embodiment can dramatically change for different applications across different architectures, while exploiting new and advanced parallel programming concepts, new software libraries (including the ones provided by the hardware manufacturer), etc.

It is understood that the various features, elements, methods or processes of the foregoing figures and descriptions are interchangeable or combinable to realize the implementations described herein. Aspects of the application can be practiced by other than the described implementations, which are presented for purposes of illustration rather than limitation, and the aspects are limited only by the claims which follow.

Based on the foregoing information, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements; the present invention being limited only by the claims appended hereto and the equivalents thereof.

What is claimed is:

1. A computer-implemented method for solving engineering problems, the method comprising:
receiving, at an interface, a geometric description of a problem domain, a partial differential equation and boundary conditions representative of an engineering problem;
converting, using a discretizer, the partial differential equation and boundary conditions in the problem domain into at least one algebraic equation;
decomposing, using a partitioner, the at least one algebraic equation into a plurality of local vectors for solution;
assigning, using a scheduler, each local vector to a processor for solution;
keeping, using an error controller, a solution error associated with each local vector less than a specified value; and
outputting, using the interface, a solution to the partial differential equation and boundary conditions,
wherein each processor solves its assigned local vectors without waiting for data from other processors or from a remote memory location while tracking the solution error associated with solving the local vectors.

2. The method of claim 1 wherein converting the partial differential equation and boundary conditions into at least one algebraic equation comprises at least one of spatial discretization and time discretization.

3. The method of claim 2 wherein converting comprises spatial discretization selected from the group consisting of Finite Element Methods (FEM), Finite Difference Methods (FDM), Finite Volume Methods (FVM), Particle Methods (PM), and Meshless Methods (MM).

4. The method of claim 2 wherein converting comprises time discretization selected from the group consisting of explicit Euler's method, implicit Euler's method, Newmark methods, Runga-Kutta methods, and multistep methods.

5. The method of claim 1 wherein the error controller for time domain analysis adapts at least one discretization parameter of each local vector independent of other local vectors to keep the solution error less than a specified value.

6. The method of claim 5 where the at least one discretization parameter is associated with time discretization, space discretization or both.

7. The method of claim 1 wherein the scheduler reassigns local vectors at runtime among the plurality of processors so as to reduce the difference in time changes or evolution across the plurality of processors.

8. The method of claim 1 wherein assigned local vectors with current data are prioritized over assigned local vectors that are waiting for data.

9. A system for solving engineering problems, the system comprising:
a memory having computer-executable instructions and data stored therein;
a plurality of processors, each processor in communication with the memory and the other processors, each processor having a queue of computational tasks;
an interface configured to receive a geometric description of a problem domain, a partial differential equation and boundary conditions representative of an engineering problem and to output a solution for the partial differential equation and boundary conditions;
a discretizer for converting the partial differential equation in the problem domain into at least one algebraic equation;
a partitioner for decomposing the at least one algebraic equation into a plurality of local vectors for solution;
a scheduler for assigning each local vector to a processor for solution; and
a bus for intermittent communications among processors and memory,
wherein each processor solves its assigned local vector without waiting for data from other processors or from a remote memory location while tracking the solution error associated with solving the local vector.

10. The system of claim 9 wherein the memory is at least one of a distributed memory architecture, a shared memory architecture, and a hierarchical memory architecture.

11. The system of claim 9 wherein the discretizer converts the partial differential equation into at least one algebraic equation using at least one of spatial discretization and time discretization.

12. The system of claim 11 wherein the discretizer utilizes spatial discretization selected from the group consisting of Finite Element Methods (FEM), Finite Difference Methods (FDM), Finite Volume Methods (FVM), Particle Methods (PM), and Meshless Methods (MM).

13. The system of claim 11 wherein the discretizer utilizes time discretization selected from the group consisting of explicit Euler's method, implicit Euler's method, Newmark methods, Runga-Kutta methods, and multistep methods.

14. The system of claim 9 wherein the error controller for time domain analysis adapts at least one discretization parameter of each local vector independent of other local vectors to keep the solution error less than a specified value.

15. The system of claim 14 wherein the at least one discretization parameter is associated with time discretization, space discretization or both.

16. The system of claim 9 wherein the scheduler reassigns local vectors at runtime among the plurality of processors so as to reduce the difference in time changes or evolution across the plurality of processors.

17. The system of claim 9 wherein assigned local vectors with current data are prioritized over assigned local vectors that are waiting for data.
